(19) United States
(12) Patent Application Publication
(10) Pub. No.: US 2024/0288532 A1
(43) Pub. Date: Aug. 29, 2024

(54) RADAR APPARATUS AND INTERFERENCE WAVE AVOIDANCE DEVICE

(71) Applicant: Mitsubishi Electric Corporation, Tokyo (JP)

(72) Inventors: Tatsuya KAMIMURA, Tokyo (JP); Osamu WADA, Tokyo (JP)

(73) Assignee: Mitsubishi Electric Corporation, Tokyo (JP)

(21) Appl. No.: 18/570,073

(22) PCT Filed: Jun. 25, 2021
(86) PCT No.: PCT/JP2021/024159

§ 371 Date: Dec. 14, 2023

(51) Int. Cl. G01S 7/02; G01S 7/35

(52) U.S. Cl. CPC G01S 7/0232; G01S 7/354

(57) ABSTRACT

A radar apparatus includes a transceiver and an interference wave avoidance device. The transceiver outputs a transmission wave that is frequency-modulated, and receives a reflected wave propagated by reflection of the transmission wave from a target and outputs a reception signal. When an interference wave that is a radio wave other than a reflected wave and that is frequency-modulated in a mode different from a mode of the transmission wave is received together with the reflected wave, the interference wave avoidance device changes a modulation frequency of the transmission wave based on a result of estimating a frequency of the interference wave received.

### FIELD

The present disclosure relates to a radar apparatus that detects a target using a transmission wave that is frequency-modulated, and to an interference wave avoidance device.

### BACKGROUND

As sensors installed in vehicles, Frequency Modulated Continuous Wave (FMCW) radars and Fast Chirp Modulation (FCM) radars are becoming widespread. Such a FMCW radar has characteristics such that a circuit configuration is simple, and signal processing is easy because a frequency band of a reception beat signal is relatively low. The FMCW radar performs an up-chirp for increasing a frequency of a transmission wave and a down-chirp for decreasing the frequency of the transmission wave, and obtains reception beat signals based on the up-chirp and the down-chirp. The FMCW radar calculates a distance to a target, a relative velocity of the target, an azimuth angle of the target, and the like, based on a difference in frequencies in the reception beat signals. On the other hand, such a FCM radar performs one of the up-chirp and the down-chirp to obtain a reception beat signal. The FCM radar calculates a distance to a target, a relative velocity of the target, an azimuth angle of the target, and the like, based on a frequency and phase information of the reception beat signal. The FCM radar can be made lower in signal processing load than the FMCW radar because of the unnecessity of pairing the up-chirp with the down-chirp. In the following description, in a case where the FMCW radar and the FCM radar are not distinguished, they are referred to as a “radar” or a “radar apparatus”.

Patent Literature 1 discloses a technique that relates to a frequency modulation circuit installed in the FMCW radar and that is for obtaining high linearity of frequency modulation.

### CITATION LIST

### Patent Literature

Patent Literature 1: Japanese Patent No. 6351910

### SUMMARY OF INVENTION

### Problem to be Solved by the Invention

With the widespread use of such radars, radars installed in vehicles are more likely to receive not only a reflected wave propagated by reflection of a transmission wave from a target, but also an interference wave that is a radio wave emitted from a radar of another vehicle.

In a radar apparatus disclosed in Patent Literature 1, signal processing is sometimes performed in a state in which a noise signal derived from an interference wave is superimposed on a reception beat signal derived from a reflected wave from a target. A decrease in a Signal to Noise Ratio (SNR) of the reception beat signal due to the superimposition of the noise signal results in deterioration of detection performance of the radar apparatus. The radar apparatus disclosed in Patent Literature 1 involves difficulty in stably detecting the target with high accuracy because its detection performance sometimes deteriorates owing to reception of the interference wave. Such difficulty is problematic.

The present disclosure has been made in view of the above, and an object of the present disclosure is to provide a radar apparatus capable of stably detecting a target with high accuracy.

### Means to Solve the Problem

In order to solve the above-described problem and achieve the object, a radar apparatus of the present disclosure includes: a transceiver to output a transmission wave that is frequency-modulated, and to receive a reflected wave propagated by reflection of the transmission wave from a target and to output a reception signal; and an interference wave avoidance device to change, when an interference wave is received together with the reflected wave, a modulation frequency of the transmission wave based on a result of estimating a frequency of the interference wave received, the interference wave being a radio wave other than the reflected wave and being frequency-modulated in a mode different from a mode of the transmission wave.

### Effects of the Invention

The radar apparatus according to the present disclosure has an effect capable of stably detecting the target with high accuracy.

### BRIEF DESCRIPTION OF DRAWINGS

FIG. 1 is a diagram illustrating a configuration of a radar apparatus according to a first embodiment.

FIG. 2 is a diagram illustrating an example of a hardware configuration of a Micro Control Unit (MCU) included in the radar apparatus according to the first embodiment.

FIG. 3 is an explanatory diagram illustrating a local signal generated by a local unit of the radar apparatus according to the first embodiment.

FIG. 4 is a diagram illustrating an example of a time-frequency characteristic of each of a transmission wave, a received desired wave, and a received interference wave in the first embodiment.

FIG. 5 is a diagram illustrating an example of a frequency modulation characteristic of each of the local signal and the received interference wave in the first embodiment.

FIG. 6 is an explanatory diagram illustrating changes in frequencies of the local signal and the received interference wave in the first embodiment.

FIG. 7 is a diagram illustrating an example of a time-frequency characteristic of a noise signal derived from the received interference wave in the first embodiment.

FIG. 8 is a flowchart illustrating an operation procedure of the radar apparatus according to the first embodiment.

FIG. 9 is an explanatory diagram illustrating control of the frequency of the local signal performed by the radar apparatus according to the first embodiment.

### DESCRIPTION OF EMBODIMENTS

Hereinafter, a radar apparatus and an interference wave avoidance device according to an embodiment will be described in detail with reference to the drawings.

### First Embodiment

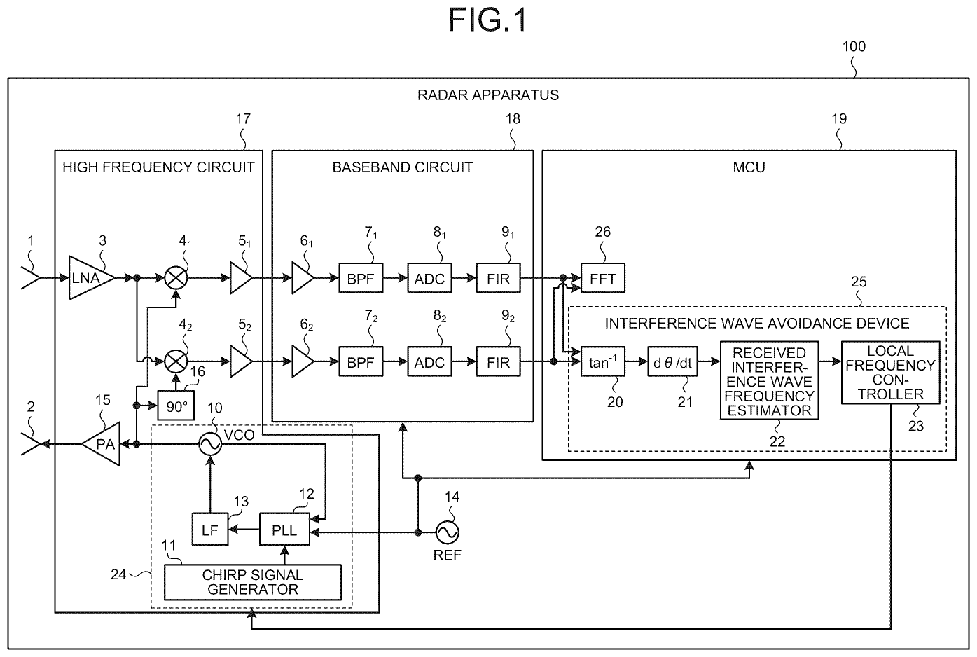

FIG. 1 is a diagram illustrating a configuration of a radar apparatus 100 according to a first embodiment. The radar apparatus 100 is installed in a vehicle. The radar apparatus 100 includes a reception antenna 1 and a transmission antenna 2 that constitute an antenna unit, a reference signal source 14 that generates a reference signal REF (REFerence signal), a high frequency circuit 17, a baseband circuit 18, and a Micro Control Unit (MCU) 19. The reference signal source 14, the high frequency circuit 17, and the baseband circuit 18 constitute a transceiver of the radar apparatus 100. The MCU 19 constitutes a signal processing unit of the radar apparatus 100.

The radar apparatus 100 illustrated in FIG. 1 is a radar including one reception channel and one transmission channel. The channel denotes a group of processing units including components of the transceiver and the signal processing unit that are processed by one reception antenna 1 or one transmission antenna 2. Note that, the number of reception channels and the number of transmission channels in the radar apparatus 100 can each be any number.

The high frequency circuit 17 outputs, via the transmission antenna 2, a transmission wave that is frequency-modulated. Additionally, the high frequency circuit 17 receives, via the reception antenna 1, a reflected wave propagated by reflection of the transmission wave from a target, and outputs a reception signal.

The high frequency circuit 17 includes a Voltage Controlled Oscillator (VCO) 10, a chirp signal generator 11 that generates a chirp signal, a Phase Locked Loop (PLL) 12, and a Loop Filter (LF) 13. The VCO 10, the chirp signal generator 11, the PLL 12, and the LF 13 constitute a local unit 24. The local unit 24 generates a modulated signal that is a frequency-modulated signal. In the following 30 description, the modulated signal generated by the local unit 24 is also referred to as a local signal.

The reference signal REF and the chirp signal are input to the PLL 12. The PLL 12 frequency-modulates the reference signal REF with a modulation pattern based on the chirp signal. The signal frequency-modulated by the PLL 12 is band-limited by the LF 13 and input to the VCO 10. The VCO 10 outputs a high-frequency signal that is the modulated signal in cooperation with the PLL 12.

Additionally, the high frequency circuit 17 includes a Low Noise Amplifier (LNA) 3, MIXers (MIXs) 4₁ and 4₂, Intermediate Frequency Amplifiers (IFAs) 5₁ and 5₂, a Power Amplifier (PA) 15, and a phase shifter 16. The PA 15 amplifies the high-frequency signal output from the VCO 10 to a desired power level. The transmission antenna 2 converts the high-frequency signal output from the PA 15 into a transmission wave that is a radio wave, and emits the transmission wave into space. The radar apparatus 100 transmits a transmission wave using a FMCW chirp signal or a FCM chirp signal.

The reception antenna 1 receives a reflected wave propagated by reflection of the transmission wave from a target, and converts the reflected wave into a reception signal. The LNA 3 amplifies the reception signal to a desired power level. The MIXs 4₁ and 4₂ each down-convert the reception signal by frequency conversion using the local signal. The MIXs 4₁ and 4₂ each reduce a frequency of the reception signal to a frequency of an Intermediate Frequency (IF) band by the down-conversion. The MIXs 4₁ and 4₂ output reception beat signals derived from the down-converted reception signal. The IFAs 5₁ and 5₂ amplify the reception beat signals to desired signal strength. The phase shifter 16 changes a phase of the reception beat signal output from the MIX 4₂ by 90 degrees. Thus, the high frequency circuit 17 outputs, from the IFAs 5₁ and 5₂, a first reception beat signal and a second reception beat signal that are two reception beat signals having phases different from each other by 90 degrees. In the following description, the first reception beat signal and the second reception beat signal are also referred to as quadrature reception beat signals.

The baseband circuit 18 converts the quadrature reception beat signals output from the high frequency circuit 17 into baseband signals having digital values. The baseband circuit 18 includes Base Band Amplifiers (BBAs) 6₁ and 6₂, Band Pass Filters (BPFs) 7₁ and 7₂, Analog to Digital Converters (ADCs) 8₁ and 8₂, and Finite Impulse Response (FIR) filters 9₁ and 9₂.

The BBAs 6₁ and 6₁ amplify the quadrature reception beat signals output from the high frequency circuit 17 to desired voltage strength. The BPFs 7₁ and 7₂ limit bands of the signals amplified by the BBAs 6₁ and 6₂. The ADCs 8₁ and 8₂ convert analog signals output from the BPFs 7₁ and 7₂ into digital signals. The FIR filters 9₁ and 9₂ limit the bands of the signals output from the ADCs 8₁ and 8₂. The baseband circuit 18 outputs the quadrature reception beat signals having been processed by the BBAs 6₁ and 6₂, the BPFs 7₁ and 7₂, the ADCs 8₁ and 8₂, and the FIR filters 9₁ and 9₂.

The MCU 19 includes an interference wave avoidance device 25 and a Fast Fourier Transform (FFT) processing unit 26. When an interference wave that is a radio wave other than the reflected wave is received together with the reflected wave, the interference wave avoidance device 25 changes a modulation frequency of the transmission wave based on a result of estimating a frequency of the interference wave, thereby avoiding superimposition of a noise signal derived from the interference wave on the reception signal. The interference wave is a radio wave that is frequency-modulated in a mode different from that of the transmission wave emitted by the radar apparatus 100, the radio wave being emitted from a radar of another vehicle.

The interference wave avoidance device 25 includes an instantaneous phase detector 20, an instantaneous frequency detector 21, a received interference wave frequency estimator 22, and a local frequency controller 23. The instantaneous phase detector 20 detects, based on the quadrature reception beat signals, an instantaneous phase of the noise signal derived from the interference wave received. The instantaneous frequency detector 21 detects, based on the instantaneous phase, an instantaneous frequency of the noise signal derived from the interference wave received. The instantaneous phase detector 20 and the instantaneous frequency detector 21 each function as a conversion unit that converts the first reception beat signal and the second reception beat signal into data representing a time and frequency characteristic of the noise signal. In the following description, the time and frequency characteristic is referred to as a time-frequency characteristic. The received interference wave frequency estimator 22 estimates the frequency of the interference wave received by the reception antenna 1, based on the data representing the time-frequency characteristic of the noise signal.

The local frequency controller 23 controls, based on a result of estimating the frequency of the interference wave received, the frequency of the local signal such that a modulation frequency band of the local signal falls outside a frequency band of the interference wave received. The local frequency controller 23 generates, based on the estimation result from the received interference wave frequency estimator 22, a control signal for adjusting the frequency of the local signal. The chirp signal generator 11 adjusts the frequency of the chirp signal in accordance with the control signal from the local frequency controller 23. As a result, the local unit 24 generates a local signal whose frequency has been adjusted in accordance with the control signal from the local frequency controller 23. In this way, the local frequency controller 23 controls the frequency of the local signal based on the result of estimating the frequency by the received interference wave frequency estimator 22.

The FFT processing unit 26 performs fast Fourier transform on the quadrature reception beat signals output from the baseband circuit 18. The FFT processing unit 26 executes radar signal processing in accordance with the fast Fourier transform to calculate a distance to the target, a relative distance of the target, an azimuth angle of the target, and the like. The distance to the target is the distance between the vehicle and the target. The relative velocity is the velocity of the target viewed from the vehicle. The azimuth angle is the angle representing the azimuth of the target with reference to the vehicle.

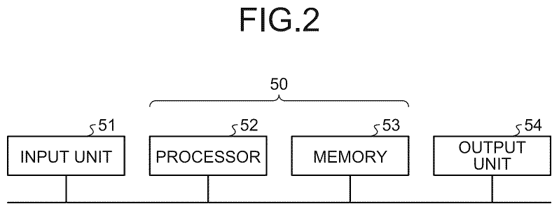

A hardware configuration of the MCU 19 will now be described. FIG. 2 is a diagram illustrating an example of the hardware configuration of the MCU 19 included in the radar apparatus 100 according to the first embodiment. The interference wave avoidance device 25 and the FFT processing unit 26 of the MCU 19 are implemented by using processing circuitry 50. The processing circuitry 50 includes a processor 52 and a memory 53.

The processor 52 is a Central Processing Unit (CPU). The processor 52 may be an arithmetic unit, a microprocessor, a microcomputer, or a Digital Signal Processor (DSP). The memory 53 is, for example, a Random Access Memory (RAM), a Read Only Memory (ROM), a flash memory, an Erasable Programmable Read Only Memory (EPROM), an Electrically Erasable Programmable Read Only Memory (EEPROM; registered trademark), or the like.

The memory 53 stores a program for operation as a signal processing unit including the interference wave avoidance device 25 and the FFT processing unit 26. The function of the signal processing unit can be implemented by the processor 52 reading and executing the program.

An input unit 51 is a circuit that receives an input signal to the MCU 19 from the outside of the MCU 19. The quadrature reception beat signals output from the baseband circuit 18 and the reference signal REF output from the reference signal source 14 are input to the input unit 51. An output unit 54 is a circuit that outputs a signal generated by the MCU 19 to the outside of the MCU 19. The output unit 54 outputs results of calculating the distance to the target, the relative distance with respect to the target, the azimuth angle of the target, and the like in the FFT processing unit 26. Additionally, the output unit 54 outputs the control signal for controlling the frequency of the local signal.

Although the configuration illustrated in FIG. 2 is an example of hardware in a case where the signal processing unit of the radar apparatus 100 is implemented by the general-purpose processor 52 and the memory 53, the signal processing unit of the radar apparatus 100 may be implemented by a dedicated processing circuitry instead of the processor 52 and the memory 53. The dedicated processing circuitry is a single circuit, a composite circuit, an Application Specific Integrated Circuit (ASIC), a Field Programmable Gate Array (FPGA), or a circuit obtained by combining these circuits. Note that, a part of the signal processing unit may be implemented by the processor 52 and the memory 53, and the remaining part may be implemented by the dedicated processing circuitry.

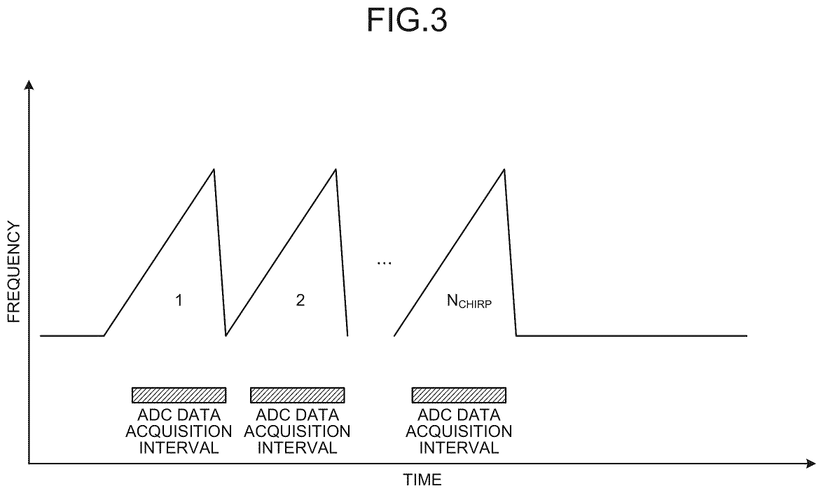

The local signal generated by the radar apparatus 100 will now be described. FIG. 3 is an explanatory diagram illustrating the local signal generated by the local unit 24 of the radar apparatus 100 according to the first embodiment. FIG. 3 illustrates, in a graph, a time-frequency characteristic of the local signal. In the graph, a horizontal axis represents time, and a vertical axis represents a frequency.

FIG. 3 illustrates an example of a waveform of the local signal that is an up-chirp signal. The up-chirp signal is a signal whose frequency increases at a constant slope with respect to time. The local signal generated by the local unit 24 is a FCM signal represented by a sawtooth wave. The number of triangular waveforms included in the sawtooth wave is N_{CMIRP} in total. The number of triangular waveforms included in the sawtooth wave can be any number. A width of each of the triangular waveforms in a horizontal axis direction represents a frequency modulation cycle. A width of each of the triangular waveforms in a vertical axis direction represents a frequency modulation bandwidth. In the following description, the slope of the graph indicated by the triangular waveform is referred to as a modulation slope. Note that, the local signal generated by the local unit 24 may be a down-chirp signal. The down-chirp signal is a signal whose frequency decreases at a constant slope with respect to time.

Furthermore, an interval indicated by hatching in FIG. 3 is an ADC data acquisition interval. The ADC data acquisition interval is an operation period of the ADCs 8₁ and 8₂ in one cycle of the local signal, the operation period being a period in which digital data is acquired by conversion in the ADCs 8₁ and 8₂.

The reflected wave and interference wave received by the radar apparatus 100 will next be described. In the following description, a reflected wave from a target is referred to as a desired wave. Additionally, the desired wave received by the reception antenna 1 is referred to as a received desired wave, and the interference wave received by the reception antenna 1 is referred to as a received interference wave.

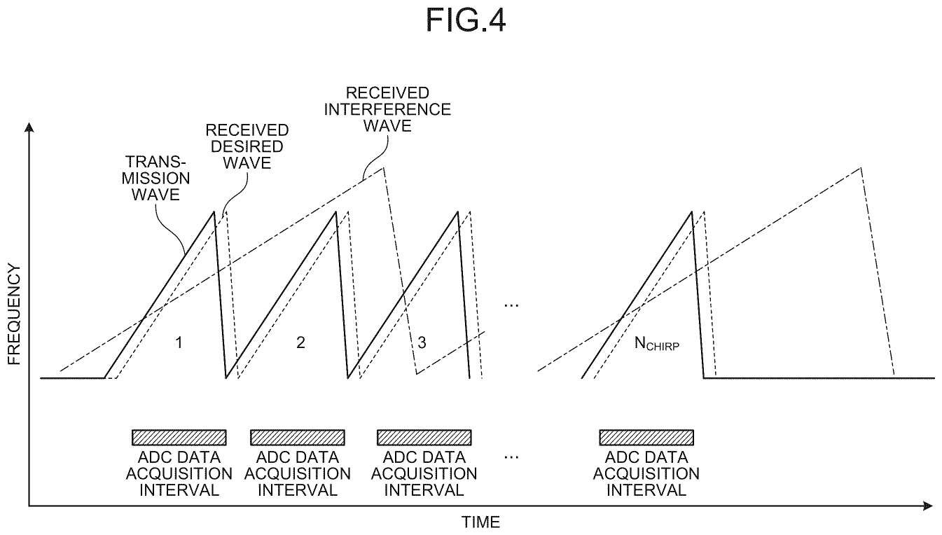

FIG. 4 is a diagram illustrating an example of a time-frequency characteristic of each of the transmission wave, the received desired wave, and the received interference wave in the first embodiment. The time-frequency characteristic of the transmission wave is the same as the time-frequency characteristic of the local signal illustrated in FIG. 3. The desired wave is received with a delay from the transmission of the transmission wave. A delay time of the received desired wave from the transmission wave corresponds to a time obtained by adding a time in which the transmission wave propagates from the transmission antenna 2 to the target and a time in which the desired wave propagates from the target to the reception antenna 1. The modulation cycle, the modulation bandwidth, and the modulation slope of the received desired wave are the same as the modulation cycle, the modulation bandwidth, and the modulation slope of the transmission wave, respectively.

The received interference wave is a radio wave transmitted from another vehicle. All of the modulation cycle, the modulation bandwidth, and the modulation slope of the received interference wave are different from the modulation cycle, the modulation bandwidth, and the modulation slope of the transmission wave, respectively. Note that, although FIG. 4 illustrates an example in which the received interference wave is the FCM signal that is the up-chirp, a FCM signal that is the down-chirp or a FMCW signal can also be the received interference wave.

Description will next be given of the quadrature reception beat signals generated in a case where the desired wave and the interference wave are simultaneously received. When the desired wave and the interference wave are simultaneously received, the high frequency circuit 17 and the baseband circuit 18 generate quadrature reception beat signals based on the received desired wave and the received interference wave.

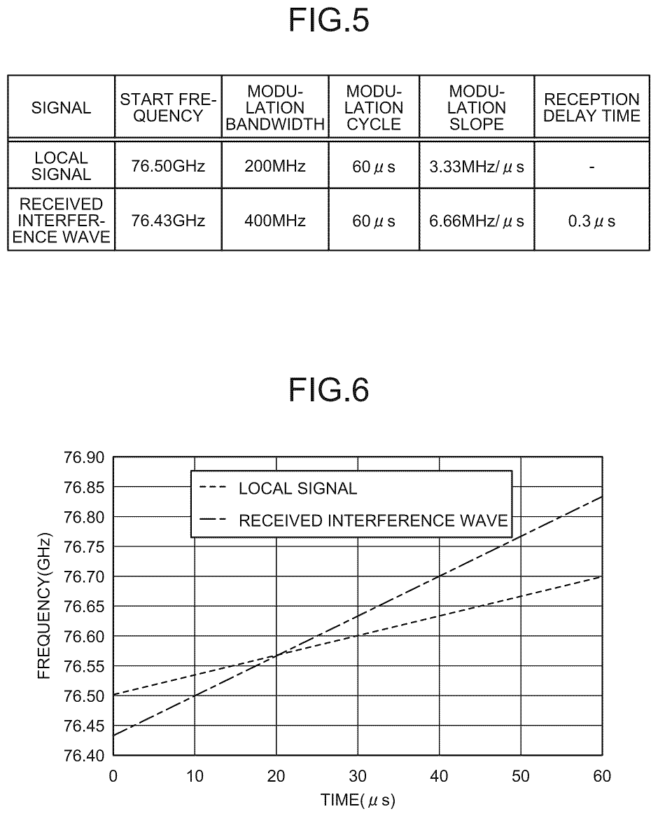

FIG. 5 is a diagram illustrating an example of a frequency modulation characteristic of each of the local signal and the received interference wave in the first embodiment. A start frequency illustrated in FIG. 5 is a frequency at a start of the modulation cycle. A reception delay time corresponds to a time from the transmission of a transmission wave from the transmission antenna 2 to the reception of an interference wave at the reception antenna 1. Each of the local signal and the received interference wave illustrated in FIG. 5 is a FCM signal. The characteristics of the local signal illustrated in FIG. 5 are also characteristics of the received desired wave. In the example illustrated in FIG. 5, a start frequency, a modulation bandwidth, and a modulation slope of the received interference wave are different from those of the received desired wave. The reception delay time of the received interference wave is different from the reception delay time of the received desired wave. Note that, the received interference wave only needs to be different from the received desired wave in at least one of the start frequency, the modulation bandwidth, the modulation slope, and the reception delay time.

FIG. 6 is an explanatory diagram illustrating changes in frequencies of the local signal and the received interference wave in the first embodiment. FIG. 6 illustrates, in a graph, a relationship between the frequencies and time of the local signal and the received interference wave in the modulation cycle. In the graph, a horizontal axis represents time, and a vertical axis represents a frequency.

The frequency of the local signal and the frequency of the received interference wave are the same at about 20 μs. At the timing when the frequency of the local signal and the frequency of the received interference wave are the same, the frequency of the reception beat signal derived from the received interference wave is 0 Hz. At the timing when the frequency of the local signal and the frequency of the received interference wave are the same, the difference between the frequency of the local signal and the frequency of the received interference wave is close to the frequency of the IF band in the radar apparatus 100. As a result, the reception beat signal derived from the received interference wave is superimposed on the reception beat signal derived from the received desired wave, which results in a decrease in the SNR of the reception beat signal derived from the received desired wave.

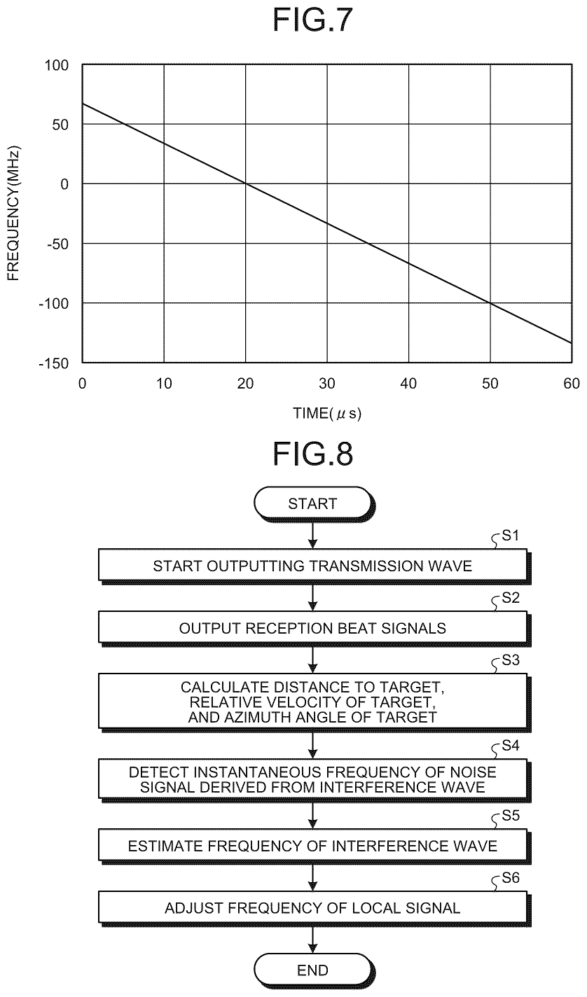

FIG. 7 is a diagram illustrating an example of the time-frequency characteristic of the noise signal derived from the received interference wave in the first embodiment. The frequency of the noise signal derived from the received interference wave corresponds to a difference between the frequency of the local signal and the frequency of the received interference wave. In a time period of 0 μs to 20 μs, the frequency of the noise signal derived from the received interference wave is positive. In a time period of 20 μs to 60 μs, the frequency of the noise signal derived from the received interference wave is negative.

Operation of the radar apparatus 100 will next be described. FIG. 8 is a flowchart illustrating an operation procedure of the radar apparatus 100 according to the first embodiment. In the following description, a frame is a cycle of detecting the target. FIG. 8 illustrates a procedure of operation of the radar apparatus 100 in a certain frame.

In step S1, the radar apparatus 100 starts outputting a transmission wave. The radar apparatus 100 receives a reflected wave propagated by reflection of the transmission wave. Here, it is assumed that the radar apparatus 100 receives a desired wave and an interference wave. The received desired wave and the received interference wave are converted into reception beat signals by the high frequency circuit 17 and the baseband circuit 18. In step S2, the baseband circuit 18 outputs the reception beat signals.

In step S3, the FFT processing unit 26 calculates a distance to a target, a relative velocity of the target, and an azimuth angle of the target based on the quadrature reception beat signals. On the other hand, in steps S4 to S6, the interference wave avoidance device 25 processes the noise signal derived from the received interference wave, based on the quadrature reception beat signals. Note that, step S3 and steps S4 to S6 can be performed in any order. Furthermore, the processing of step S3 and the processing of steps S4 to S6 may be performed simultaneously.

In step S4, the interference wave avoidance device 25 detects an instantaneous frequency of the noise signal derived from the interference wave. The instantaneous phase detector 20 detects an instantaneous phase of the noise signal derived from the received interference wave, based on the quadrature reception beat signals. The instantaneous frequency detector 21 detects an instantaneous frequency of the noise signal derived from the received interference wave, based on the detected instantaneous phase. In step S5, the received interference wave frequency estimator 22 estimates the frequency of the interference wave based on the instantaneous frequency detected in step S4. The received interference wave frequency estimator 22 detects the frequency of the noise signal derived from the received interference wave by obtaining the difference between the frequency of the local signal and the frequency of the received interference wave.

Description will now be given of an example of a method for estimating a frequency in the received interference wave frequency estimator 22. The received interference wave frequency estimator 22 obtains the time when the noise signal derived from the received interference wave is 0 Hz, based on the data representing the time-frequency characteristic obtained by sweeping the frequency of the noise signal derived from the received interference wave from the positive frequency to the negative frequency as illustrated in FIG. 7.

On the other hand, the time-frequency characteristic of the local signal generated by the local unit 24 is information known in the MCU 19 because the MCU 19 controls the high frequency circuit 17. The received interference wave frequency estimator 22 obtains, based on the data representing the time-frequency characteristic of the local signal, the frequency of the local signal at the timing when the noise signal derived from the received interference wave is 0 Hz, that is, at the timing when the frequency of the local signal and the frequency of the received interference wave are the same. As a result, the received interference wave frequency estimator 22 obtains an estimated value of the frequency of the received interference wave.

In step S6, the local frequency controller 23 adjusts the frequency of the local signal based on the frequency estimated in step S5. The local frequency controller 23 outputs the control signal for adjusting the frequency of the local signal. The chirp signal generator 11 adjusts the frequency of the chirp signal in accordance with the control signal from the local frequency controller 23. The radar apparatus 100 adjusts the frequency of the chirp signal in accordance with the control signal, thereby controlling the frequency of the local signal based on the result of estimating the frequency of the received interference wave. Accordingly, the radar apparatus 100 ends the operation according to the procedure illustrated in FIG. 8. Thereafter, the operation of the radar apparatus 100 shifts to operation of the next frame.

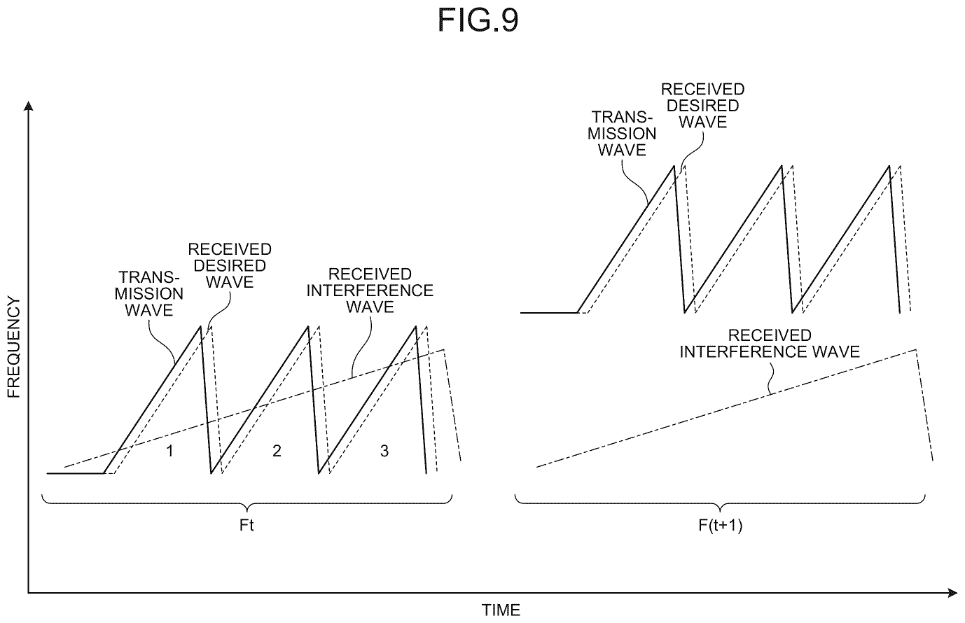

FIG. 9 is an explanatory diagram illustrating control of the frequency of the local signal performed by the radar apparatus 100 according to the first embodiment. It is assumed that, in a certain frame Ft, the desired wave and the interference wave are simultaneously received, and thus, quadrature reception beat signals are generated based on the received desired wave and the received interference wave. Through the operation of steps S1 to S6 in the frame Ft, the interference wave avoidance device 25 controls the frequency of the local signal such that the modulation bandwidth of the local signal falls outside the frequency band of the received interference wave. In a frame F(t+1) next to the frame Ft, the radar apparatus 100 outputs a transmission wave using a local signal in a frequency band deviated from the frequency band of the received interference wave.

In this way, when the interference wave is received together with the reflected wave, the interference wave avoidance device 25 changes the frequency band of the transmission wave based on the result of estimating the frequency of the interference wave, thereby avoiding superimposition of the noise signal derived from the interference wave on the reception signal. The radar apparatus 100 can prevent the superimposition of the reception beat signal derived from the noise signal derived from the interference wave on the reception beat signal derived from the received desired wave, thereby preventing a decrease in the SNR of the reception beat signal derived from the received desired wave.

An algorithm for detecting an instantaneous phase based on the quadrature reception beat signals and detecting the frequency of the noise signal derived from the interference wave based on the instantaneous phase is resistant to system noise. Thus, the interference wave avoidance device 25 detects the frequency of the noise signal derived from the interference wave with high accuracy.

According to the first embodiment, in the case where the reception beat signal derived from the received interference wave is superimposed on the reception beat signal derived from the received desired wave, the radar apparatus 100 causes the interference wave avoidance device 25 to detect the frequency of the received interference wave and to control the frequency of the local signal such that the modulation bandwidth of the local signal falls outside the frequency band of the received interference wave. The interference wave avoidance device 25 can detect the frequency of the received interference wave without providing an independent interval for detecting the frequency of the received interference wave. Thus, the interference wave avoidance device 25 can shorten a time from the detection of the interference wave to the avoidance of the superimposition of the reception beat signal derived from the received interference wave on the reception beat signal derived from the received desired wave. Additionally, the interference wave avoidance device 25 can expand an interval in which the noise signal derived from the interference wave can be monitored. The interference wave avoidance device 25 can improve resistance to an interference wave that is expected to arrive at random in time. Since the interference wave avoidance device 25 can estimate the frequency of the received interference wave with high accuracy, the interference wave avoidance device 25 can control the frequency of the local signal for avoiding the interference wave with high accuracy and high reliability. Accordingly, the radar apparatus 100 has an effect capable of stably detecting the target with high accuracy.

The configurations described in the above embodiment are an example of the contents of the present disclosure. The configurations of the above embodiment may be combined with another known technique. Some of the configurations of the above embodiment may be omitted or changed without departing from the gist of the present disclosure.

### REFERENCE SIGNS LIST

1 reception antenna; 2 transmission antenna; 3 LNA; 4₁, 4₂ MIX; 5₁, 5₂ IFA; 6₁, 6₂ BBA; 7₁, 7₂ BPF; 8₁, 8₂ ADC; 9₁, 9₂ FIR filter; 10 VCO; 11 chirp signal generator; 12 PLL; 13 LF; 14 reference signal source; 15 PA; 16 phase shifter; 17 high frequency circuit; 18 baseband circuit; 19 MCU; 20 instantaneous phase detector; 21 instantaneous frequency detector; 22 received interference wave frequency estimator; 23 local 10 frequency controller; 24 local unit; 25 interference wave avoidance device; 26 FFT processing unit; 50 processing circuitry; 51 input unit; 52 processor; 53 memory; 54 output unit; 100 radar apparatus.

1.-7. (canceled)

8. A radar apparatus comprising:
a transceiver to output a transmission wave that is frequency-modulated, and to receive a reflected wave propagated by reflection of the transmission wave from a target and to output a reception signal; and
an interference wave avoidance processor to change, when an interference wave is received together with the reflected wave, a modulation frequency of the transmission wave based on a result of estimating a frequency of the interference wave received, the interference wave being a radio wave other than the reflected wave and being frequency-modulated in a mode different from a mode of the transmission wave, wherein
the transceiver outputs a first reception beat signal and a second reception beat signal to the interference wave avoidance processor, the first reception beat signal being generated by down-converting the reception signal, the second reception beat signal being generated by down-converting the reception signal and changing a phase of the reception signal after down-conversion by 90 degrees, and
the interference wave avoidance processor estimates a frequency of the interference wave based on the first reception beat signal and the second reception beat signal.

9. The radar apparatus according to claim 8, wherein
the transceiver outputs the transmission wave that is a radio wave converted from a local signal that is frequency-modulated, and
the interference wave avoidance processor includes a local frequency controller to control, based on the result of estimating the frequency of the interference wave received, a frequency of the local signal such that a modulation frequency band of the local signal falls outside a frequency band of the interference wave.

10. The radar apparatus according to claim 8, wherein
the interference wave avoidance processor includes:
a converter to convert the first reception beat signal and the second reception beat signal into data representing a time and frequency characteristic of a noise signal derived from the interference wave received; and
a received interference wave frequency estimator to estimate, based on the data representing the time and frequency characteristic of the noise signal, the frequency of the interference wave received.

11. The radar apparatus according to claim 9, wherein
the interference wave avoidance processor includes:
a converter to convert the first reception beat signal and the second reception beat signal into data representing a time and frequency characteristic of a noise signal derived from the interference wave received; and
a received interference wave frequency estimator to estimate, based on the data representing the time and frequency characteristic of the noise signal, the frequency of the interference wave received.

12. The radar apparatus according to claim 10, wherein
the converter includes:
an instantaneous phase detector to detect, based on the first reception beat signal and the second reception beat signal, an instantaneous phase of the noise signal derived from the interference wave received; and
an instantaneous frequency detector to detect an instantaneous frequency of the noise signal based on the instantaneous phase.

13. The radar apparatus according to claim 11, wherein
the converter includes:
an instantaneous phase detector to detect, based on the first reception beat signal and the second reception beat signal, an instantaneous phase of the noise signal derived from the interference wave received; and
an instantaneous frequency detector to detect an instantaneous frequency of the noise signal based on the instantaneous phase.

14. The radar apparatus according to claim 8, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

15. The radar apparatus according to claim 9, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

16. The radar apparatus according to claim 10, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

17. The radar apparatus according to claim 11, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

18. The radar apparatus according to claim 12, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

19. The radar apparatus according to claim 13, wherein
the transmission wave is transmitted using a Frequency Modulated Continuous Wave (FMCW) chirp signal or a Fast Chirp Modulation (FCM) chirp signal, and
the interference wave is different from the reflected wave in at least one of a modulation bandwidth, a start frequency that is a frequency at a start of a modulation cycle, a modulation slope that is a slope of a graph representing a waveform, and a reception delay time that corresponds to a time from transmission of the transmission wave to reception of the interference wave.

20. An interference wave avoidance processor included in a radar apparatus to output a transmission wave that is a radio wave converted from a local signal that is frequency-modulated and to receive a reflected wave propagated by reflection of the transmission wave from a target, the interference wave avoidance processor comprising:
a converter to convert a reception signal in a case where the reflected wave and an interference wave are simultaneously received, into data representing a time and frequency characteristic of a noise signal derived from the interference wave, the interference wave being a radio wave other than the reflected wave and being frequency-modulated in a mode different from a mode of the transmission wave;
a received interference wave frequency estimator to estimate, based on the data representing the time and frequency characteristic of the noise signal, a frequency of the interference wave received; and
a local frequency controller to control, based on a result of estimating the frequency of the interference wave received, a frequency of the local signal such that a modulation frequency band of the local signal falls outside a frequency band of the interference wave, wherein
the converter includes:
an instantaneous phase detector to detect, based on a first reception beat signal and a second reception beat signal, an instantaneous phase of the noise signal derived from the interference wave received, the first reception beat signal being generated by down-converting the reception signal, the second reception beat signal being generated by down-converting the reception signal and changing a phase of the reception signal after down-conversion by 90 degrees; and
an instantaneous frequency detector to detect an instantaneous frequency of the noise signal based on the instantaneous phase.
